(19) United States
(12) Patent Application Publication
(10) Pub. No.: US 2011/0039049 A1
(43) Pub. Date: Feb. 17, 2011

(54) MOLDED FOAMED ARTICLES AND METHOD OF MAKING SAME

(76) Inventor: Kwong Lam Thomas Chow, Kwun Tong (HK)

Correspondence Address: HOLLAND & HART, LLP, P.O BOX 8749, DENVER, CO, 80201, US

(21) Appl. No.: 12/989,028

(22) PCT Filed: Apr. 21, 2009
(86) PCT No.: PCT/CN2009/071383

§ 371 Date: Oct. 21, 2010

Related U.S. Application Data
(60) Provisional application No. 61/046,672, filed on Apr. 21, 2008.
(60) Provisional application No. 61/091,109, filed on Aug. 22, 2008.

(51) Int. Cl. B29C 44/12; B29C 44/14; B29C 44/18; B29C 44/58; B32B 3/26; B32B 27/40

(52) U.S. Cl. 428/71; 264/46.6

(57) ABSTRACT

A molded foam article (100) comprises a foamed core (110) of an expanded non-thermoplastic foam material which is bonded to a skin (120) of an un-expanded or a minimally expanded non-thermoplastic material. Polyurethane is a suitable non-thermoplastic material. The skin (120) may be compressively molded of un-expanded polyurethane, and the foamed core (110) is formed using water as blowing agents.

### FIELD OF THE INVENTION

The present invention relates to molded foamed articles, and more particularly, to molded foam articles including a skin and a formed core, such as arm rests, seats, toys, doll faces, computer peripherals and accessories and the like. This invention also relates to methods of molding polyurethane foamed articles.

### BACKGROUND OF INVENTION

Articles comprising a foamed core embraced by an outer skin are known. For example, arm rests, padded seats, and toy balls comprise a resilient foamed core embraced by a protective outer skin. Traditionally, foamed articles comprising an outer skin can be formed by a self-skinning process using self-skinning foam or integral skin polyurethane (PU) foam as described in U.S. Pat. No. 3,664,976, or by first forming a polyurethane skin by spraying and then forming a foamed polyurethane core by “water blowing” as described in WO2007/115396. The use of PU to produce foamed articles with water as a blowing agent is expected to become more widespread due to the more environmentally friendly properties of PU compared to the adverse properties of polyvinyl chloride to the environmental.

Shortcomings of conventional foamed article methods are known. For example, the self-skinning process requires non-environmental and somewhat hazardous blowing agents. On the other hand, the spraying method is not material efficient and is more expensive, and the article shape suitable for production by this method is more restricted. Also, the armrest of WO 2007/115396 includes an outer skin which only covers the top portion of the foamed article, it is noted that such an outer skin is easily peeled off and is therefore not desirable for use in durable furniture.

Hence, an improved method of making foamed articles and/or an improved foamed article would be beneficial.

### SUMMARY OF THE INVENTION

According to the present invention, there is provided a molded foam article comprising a foamed core of an expanded non-thermoplastic foam material which is bonded to a skin of an un-expanded non-thermoplastic material. Polyurethane is a suitable non-thermoplastic material.

The skin may be compressively molded of un-expanded polyurethane, and the foamed core is formed using water as blowing agents for foaming. Unexpanded polyurethane promotes a smooth surface which is preferred for many applications.

Such a foamed article is advantageous because less environmentally damaging chemical materials could be used to form the article, and the thickness of the skin could be more accurately controlled.

The skin may comprise a first surface portion which is intermediate the lateral wrap-around portions which define a lateral extent of the foamed core; and wherein each of the lateral wrap-around portions extends transversely in a continuous and/or jointless manner from the first surface portion.

A foamed article comprising a continuous wrap around portion mitigates the presence of longitudinal weakness lines which are commonly found on such articles, such weakness lines are usually under tension and are frequently the cause of surface cracking of such articles which tend to shorten the usable life of the articles.

The skin is compressively molded from an unexpanded non-thermoplastic foam material such as polyurethane.

According to another aspect of the present invention, there is provided a process of forming a foam article by molding on molds which comprises an upper mold, a lower mold and a mold core, the upper and lower molds collectively defining a molding cavity for receiving the mold core, the mold core being arranged to form a skin upon closure of the upper and lower molds and when the molding cavity is filled with a skin forming agent, the process comprising:
delivering a skin forming agent into the molding cavity,
inserting the mold core into the molding cavity, the mold core being arranged to compressively form a skin layer upon closure of the lower and upper molds,
curing the skin forming agent with no or minimal expansion to form a skin layer,
delivering a foaming agent into the cavity formed with the skin layer, and
curing the foaming agent to form a foamed core.

A non-thermoplastic material such as polyurethane may be a suitable skin forming agent for use in this process. A preferred density of the polyurethane skin forming agent may be in the region of 1, and the density of the foamed core of expanded non-thermoplastic material is far below 1.

### BRIEF DESCRIPTION OF PREFERRED EMBODIMENTS

Preferred embodiments of the present invention will now be explained by way of example and with reference to the accompanying drawings in which:

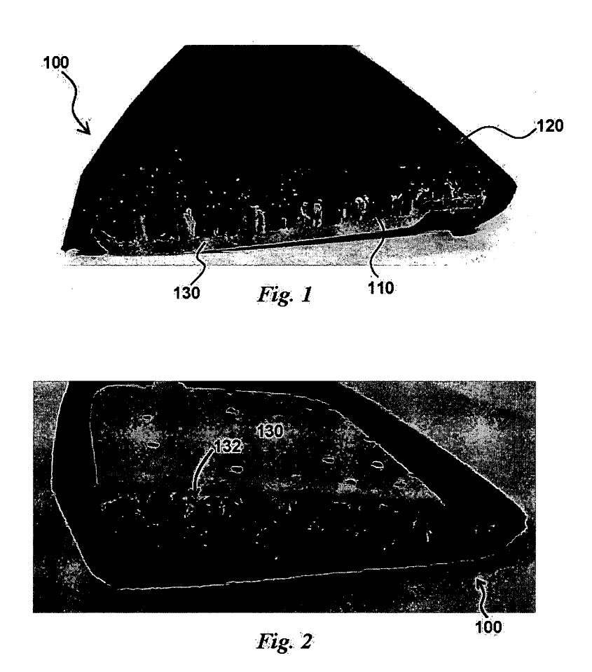

FIG. 1 is a top perspective view of an embodiment of an armrest partially cut-up and exposing a transversal cross-section,

FIG. 2 is a bottom perspective view of the article of FIG. 1,

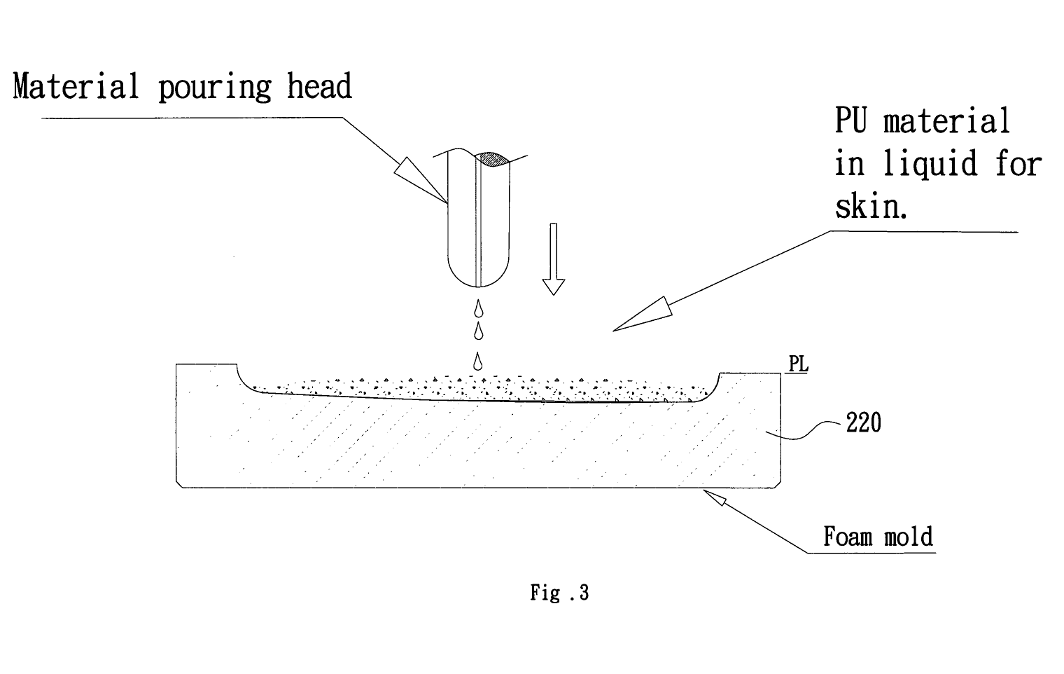

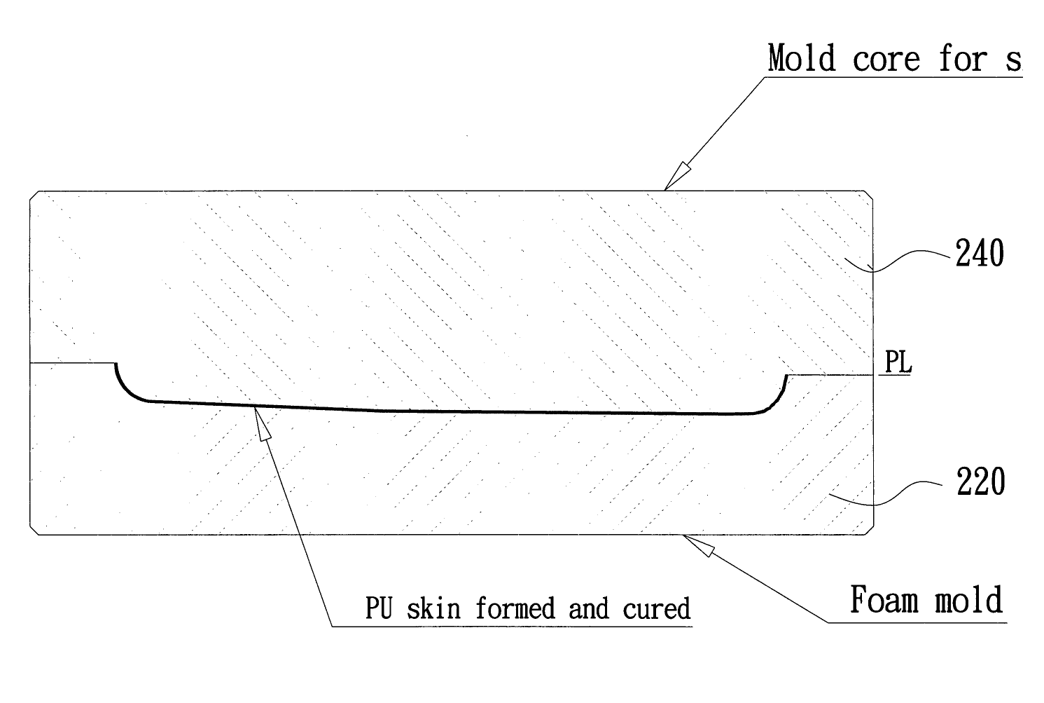

FIG. 3 is cross-sectional view depicting a lower mold which is being filled with a skin forming agent,

FIG. 4 shows the formation of a skin layer portion by compressive moulding according to one aspect of the present invention,

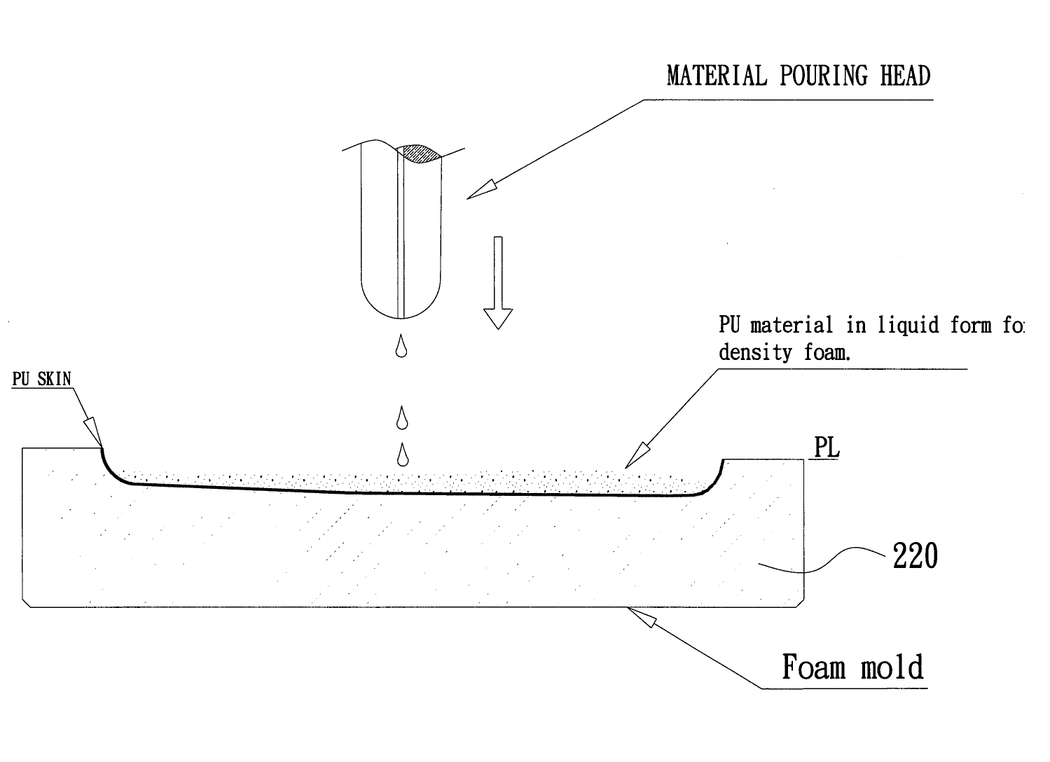

FIG. 5 depicts delivery of a core forming agent into the lower mould of FIG. 3 subsequent to the formation of the skin layer,

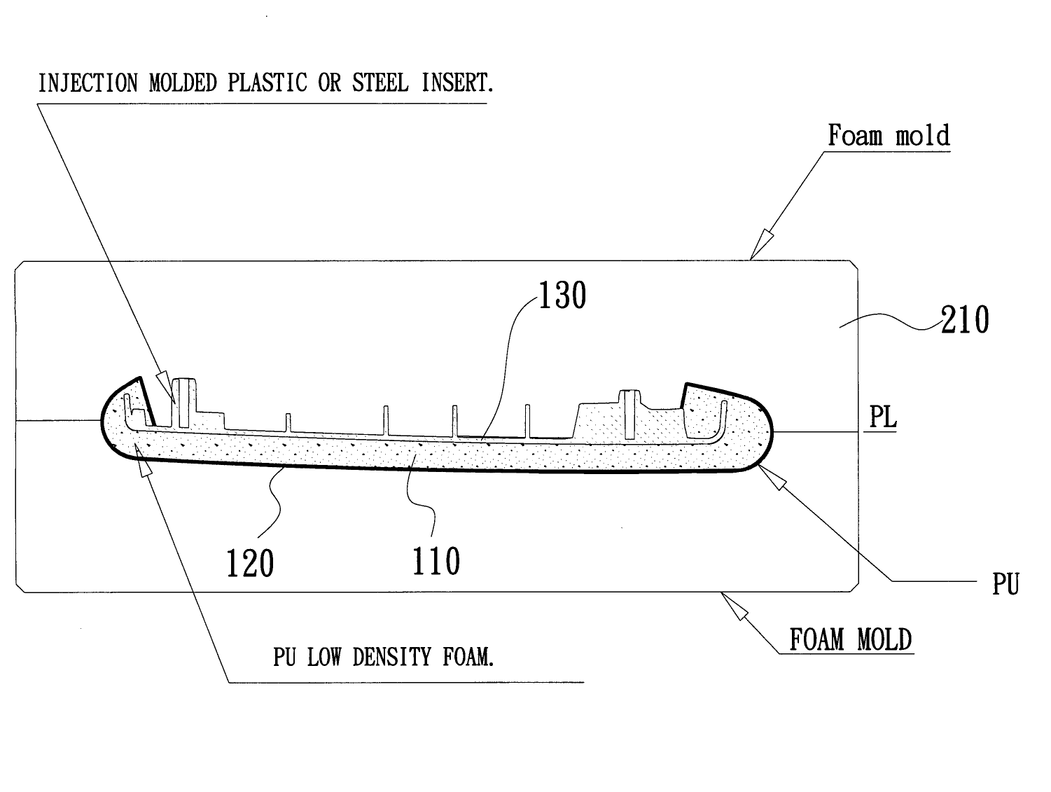

FIG. 6 depicts a set of upper and lower molds for the formation of a complete arm rest following the step of FIG. 5,

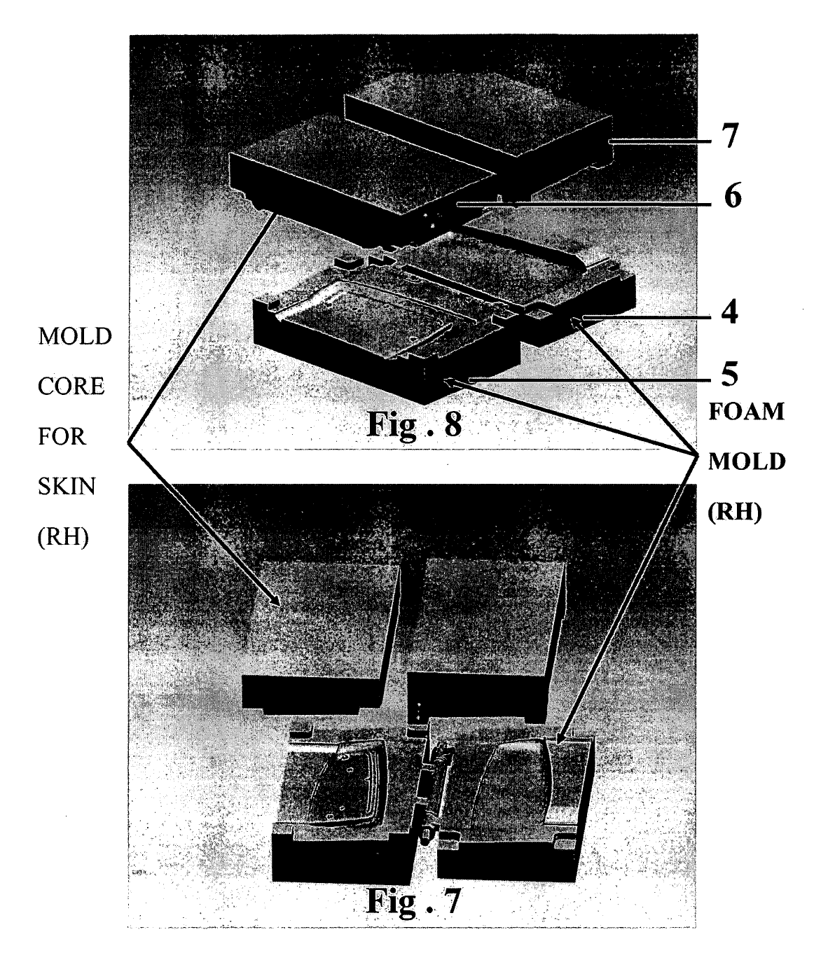

FIG. 7 is a perspective view showing a foam mould and a mold core,

FIG. 8 is a perspective view of FIG. 7 from another angle,

FIG. 9 is a perspective view of FIG. 7 from yet another angle,

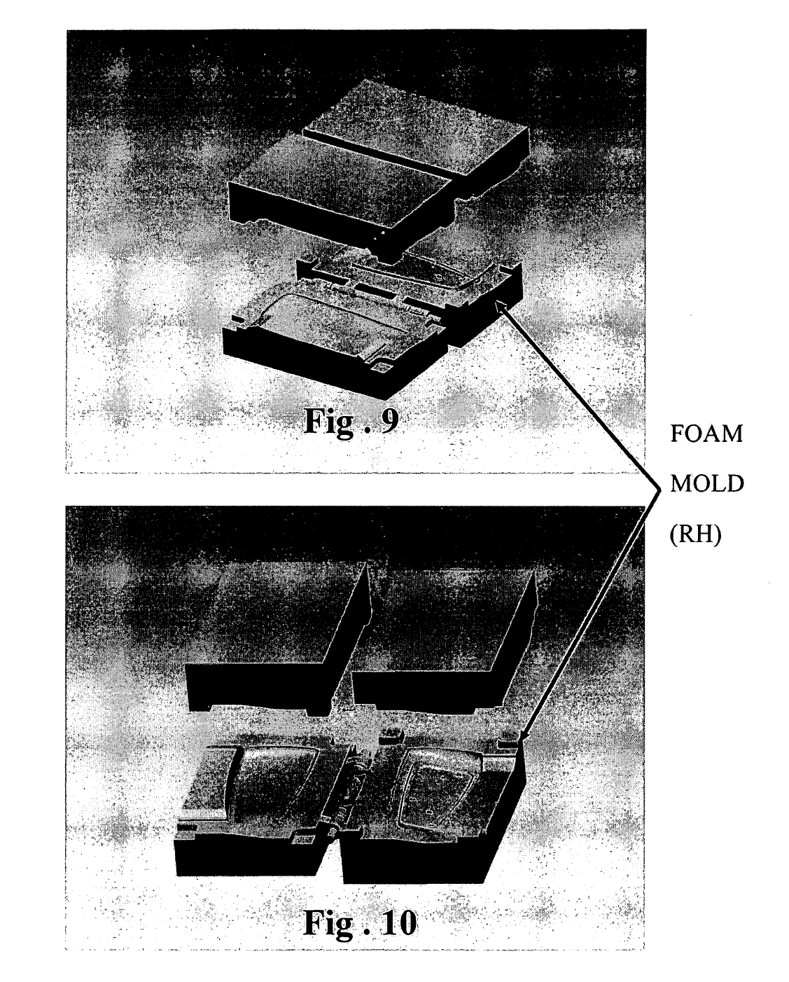

FIG. 10 is a perspective view of FIG. 7 from another end,

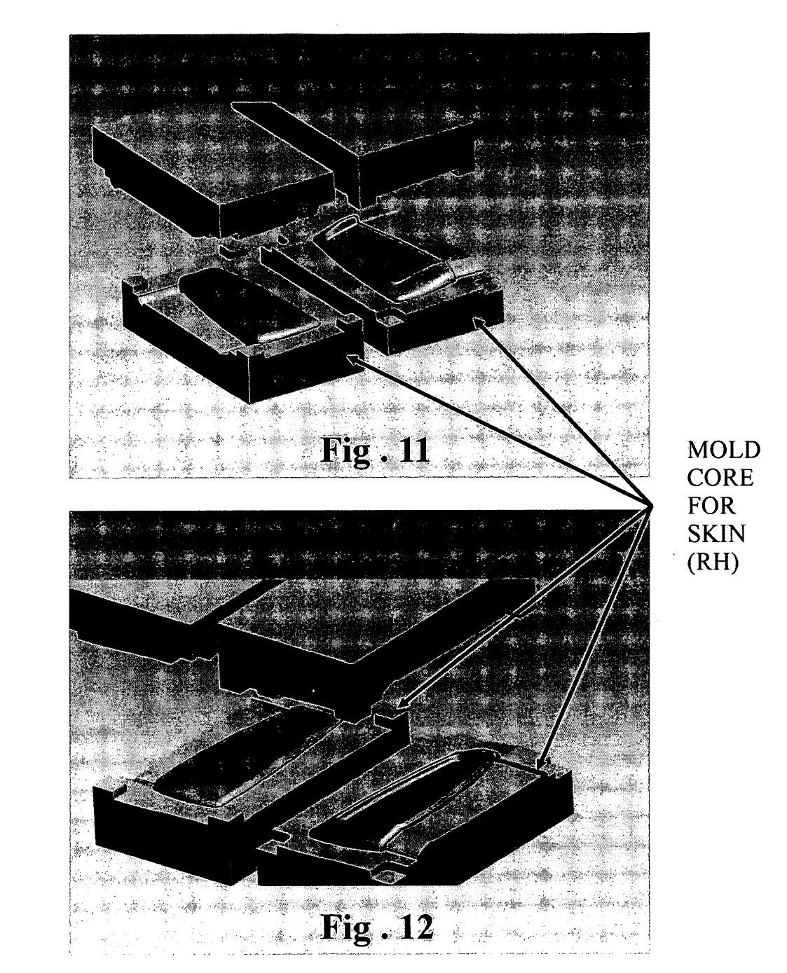

FIG. 11 is a perspective view of the mould core,

FIG. 12 is a perspective view of the mould core from another angle,

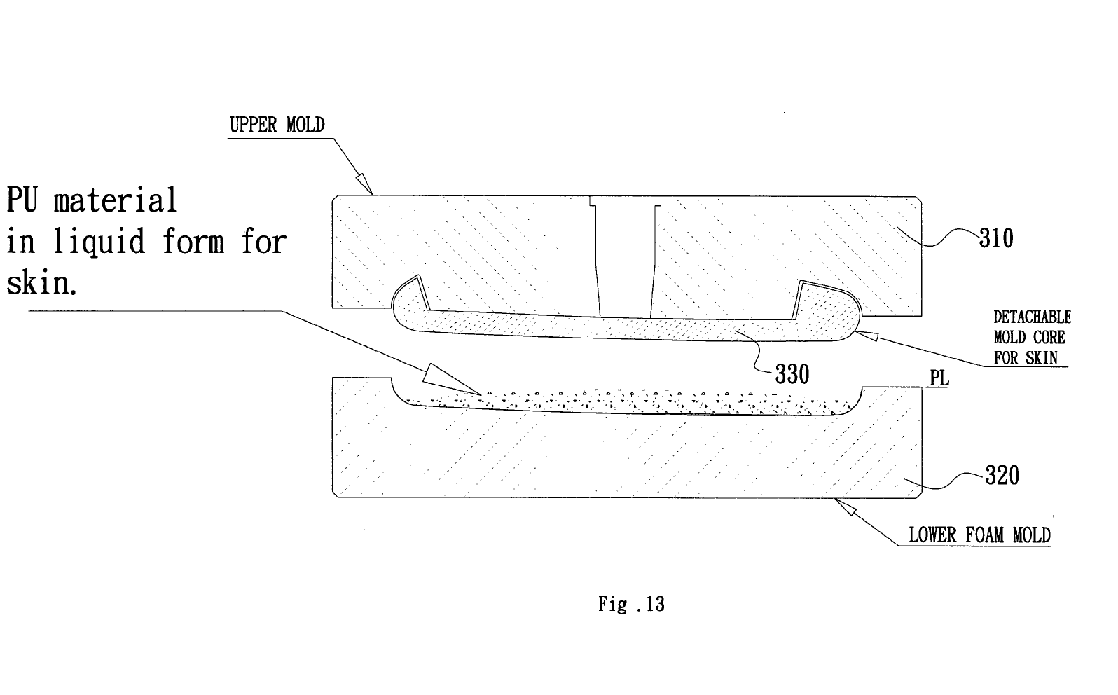

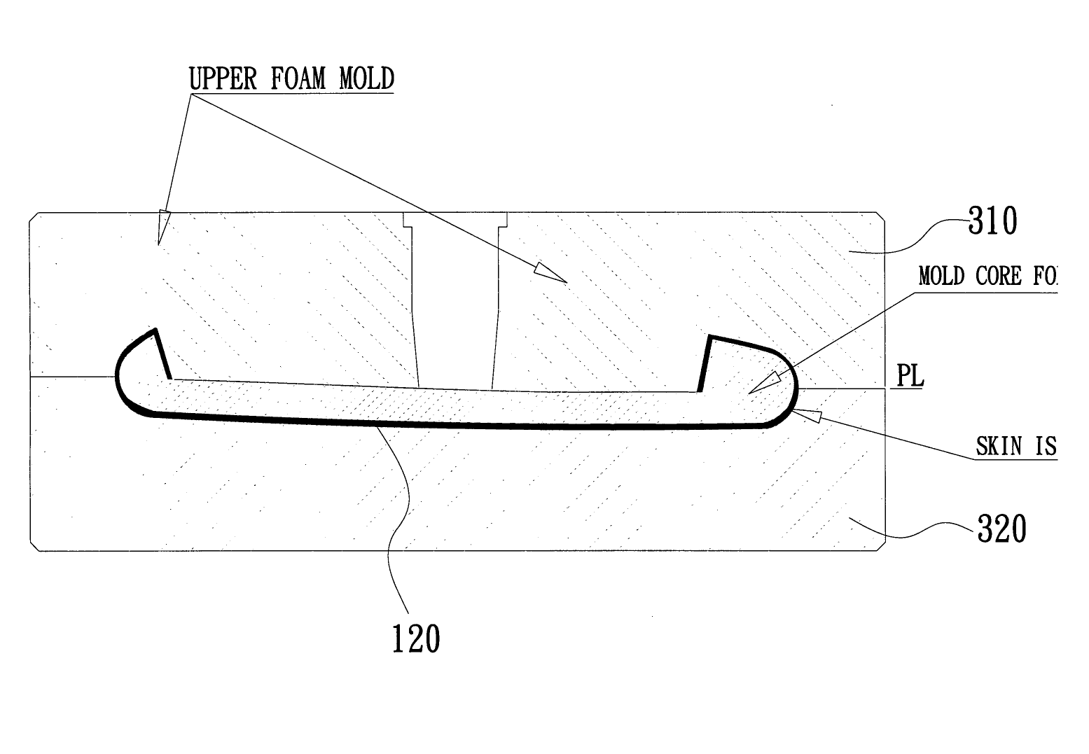

FIG. 13 is a cross-sectional view depicting the filling of a skin forming agent into a lower mould for formation of a skin layer with wrap-around portions using the upper and lower moulds in combination,

FIG. 14 illustrates the formation of a skin layer by compressive molding using the upper and lower moulds,

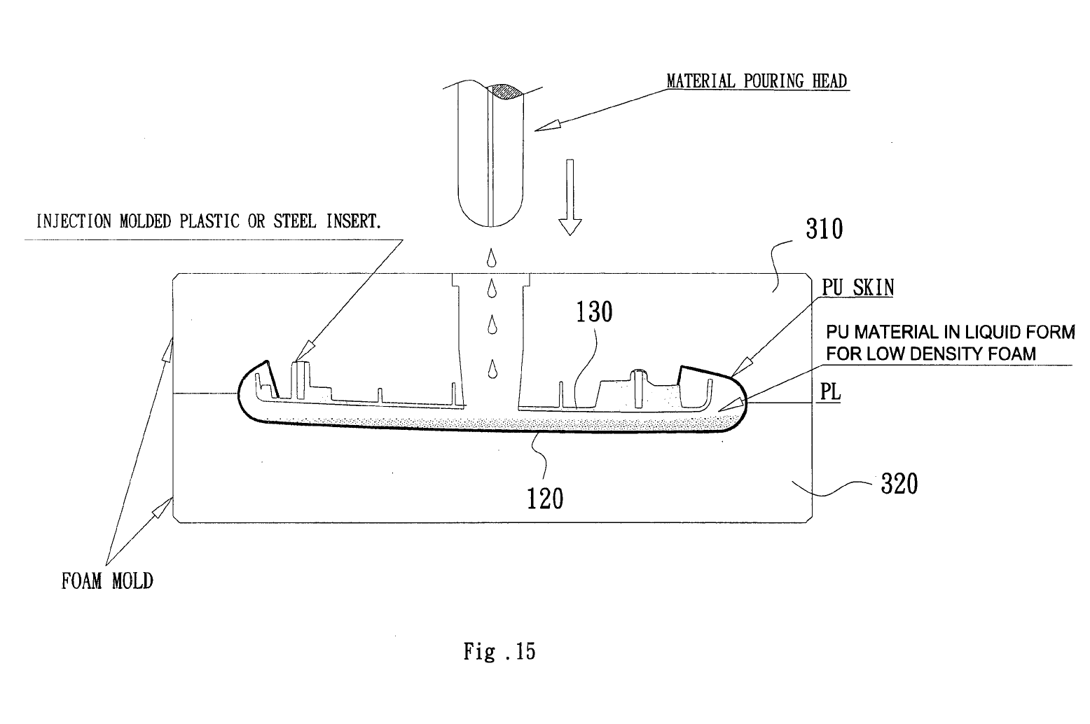

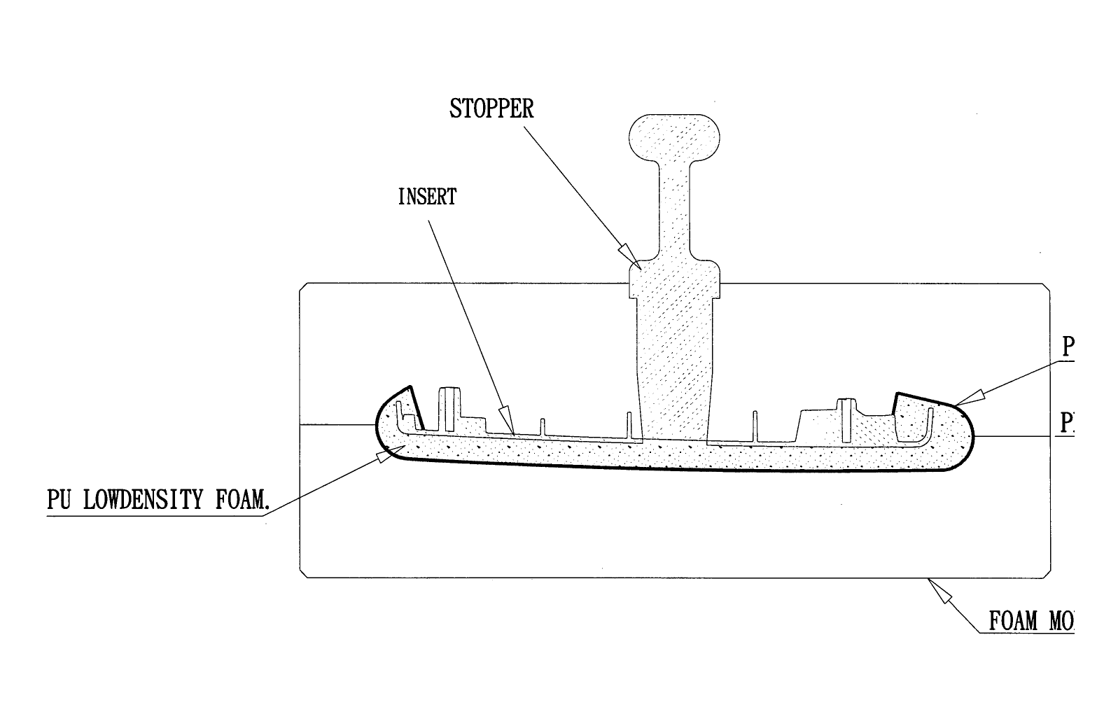

FIG. 15 depicts the filling of a core forming agent into the moulds after a skin layer has been formed and a rigid insert is in place, and

FIG. 16 illustrates the in-mould formation of an arm rest with a foamed core and an outer skin.

### DETAILED DESCRIPTION OF PREFERRED EMBODIMENTS

Referring to FIGS. 1 and 2, an armrest 100 as an exemplary embodiment of a foamed article of the present invention comprises a molded foamed core 110 of expanded polyurethane which is sandwiched between a molded outer skin 120 and a rigid insert 130. The foamed core is molded into the shape of an armrest and comprises opposite major surface portions separated by opposite minor surface portions. Each of the minor surface portions define a lateral end of the arm rest and includes curved bends such that the lateral ends is formed into a rounded shape and comprises which define the lateral extremities of the armrest. The lateral extremities are rounded for ergonomic and safety considerations.

The rigid insert is molded of hard plastics such as polycarbonate and comprises a plurality of longitudinally extending ribs which protrudes upwardly from its upper surface. The ribs are embedded into the lower major surface during the formation process of the foamed core. The lower surface of the rigid insert is for attaching to a chair frame and therefore comprises anchoring means for such purposes. The rigid insert could also be made of steel, alloys or other materials.

An outer skin of a compressively molded polyurethane layer is formed as a protective skin which is bonded to the foamed core. The bonded outer layer extends transversely across the entire upper major surface and the lateral ends of the foam core until it is finally bonded to the lateral sides of the rigid insert. Specifically, the outer skin is a single piece of a compressively molded layer which continuously wraps around the outer surface of the foamed core, such that the foamed core is totally embraced by the outer skin and the rigid insert. The continuity of the outer skin at the lateral ends means that there is no longitudinally running joint on the lateral bends which is found in a skinned elongate article such as an armrest. Such a joint at the bends is an exposed weakness which is under constant tension, and would easily develop into cracks and resulting in the peeling off of the outer skin, especially when the bends are subject to constant impact.

Turning next to the formation of the armrest of a first embodiment of the present invention, an exemplary molding process is illustrated with reference to a set of exemplary molds and FIGS. 3-6. The set of exemplary molds comprises an upper mold 210 and a lower mold 220 which are designed to form a skin of foamed polyurethane compressively upon mold closure and material curing.

Referring to FIG. 3, a quantity of liquid polyurethane prepared for skin forming is introduced into the lower mold, as depicted in FIG. 3. After a predetermined quantity of liquid polyurethane has been introduced, a mold core 240 for skin forming is put in place and stacked on the lower mold as shown in FIG. 4. The polyurethane liquid is then allowed to cure without expansion to form a skin layer. Because of the complementary shapes of the mold core 240 and the lower mold 220, a polyurethane skin of a predetermined thickness will be formed by compression while undergoing a chemical reaction, usually with heating. The skin thus formed could have a thickness of less than 1.5 mm, or even 1 mm or lower. Similarly, the remaining portion of the skin is formed on the upper mold by cooperation between the upper mold and its mold core. More particularly, the mold core is shaped with a molding cavity and is adapted to cooperate with the upper mold to form the remaining portion of the skin. When the upper and lower molds are closed, a complete skin will be formed.

While the upper and lower skin portions are still in the upper and lower molds respectively, an adhesive agent is applied to the free surface of the skin portions to promote bonding with the foamed core to be formed. Next, a polyurethane foaming agent for forming a lower density molded foam core is introduced into the lower mold, as depicted in FIG. 5. This core forming foaming agent has a higher expansion rate compared to the skin forming agent (which is not or only very minimally expanded), and is expanded by using water as a blowing agent to form a core of open cell structure after curing. Next, the upper mold with a molding cavity shaped to receive the rigid insert is stacked on the lower mold after the rigid insert is put in place, and an adhesive agent is also applied to promote bonding with the upper and lower skin. After the upper and lower molds are brought together and closed, as shown in FIG. 6, heat is applied to cure the foaming agent to form the foamed core, and an armrest comprising a foamed polyurethane core is formed. FIGS. 7-12 show in more detail a set of molds, comprising an upper mold, a lower mold and a mold core, for use in this exemplary embodiment.

Referring to FIGS. 13-16, the formation of an armrest of a second embodiment of the present invention comprising an outer skin which continuously wraps around the lateral bends of the armrest will be explained. The molds used in illustrating this formation process are substantially identical to that of the first embodiment, except that an additional mold core 330 is also required. Specifically, the molds comprise an upper mold 310, a lower mold 320 and a mold core 330, wherein the upper and lower molds collectively defining a molding cavity for receiving the mold core. The mold core is rigid and is arranged to form a skin by mold compression upon closure of the upper and lower molds and when the molding cavity is filled with a skin forming agent. According to an embodiment of the present invention, the skin forming agent is delivered into the molding cavity by open mold pour.

The mold core is for attaching to the molding cavity of the upper mold during molding operation and is shaped to define a skin forming space when so attached and upon closure of the upper and lower molds. Referring to FIG. 13, the mold core is shaped to cooperate with the molding cavity of the lower mold to define a first skin forming gap, and is shaped to cooperate with the molding cavity of the upper mold to define a second skin forming gap, the first and second skin forming gaps collectively define a complete skin forming gap when the upper and lower molds are closed with the mold core in place. In particular, the mold core comprises a wrap around portion at each lateral end which is arranged to maintain a skin forming gap with both the upper and lower molds upon closure of the molds.

To form the skin, a skin forming liquid polyurethane is introduced into the molding cavity of the lower mold, and the molds completed with the mold core are then closed. This closure causes the liquid to fill the gap between the mold core and the lower mold, as well as the gap between the mold core and the upper mold, whereby a soft skin with continuous wrap-around portions at the lateral ends is formed upon curing of the compressed foaming material. Similar to the first embodiment, the polyurethane used as a skin forming agent is not expanded, so that a smooth surface substantially of a non-open cell structure or substantially free of open cells could be obtained.

After the skin has been formed as shown in FIG. 14, the next step is to form the foamed core. In this step, a rigid insert 130 is firstly attached to the upper mold, and the upper and lower molds are closed. The rigid insert is provided with a bore which is aligned with a bore formed on the upper mold so that core-forming foaming agents could be delivered to the molding cavity via the bores, as shown more particularly in the cross-sectional view of FIG. 15. After the insert has been attached to the upper mold, and the upper and lower mold closed, core-forming foaming agent is delivered into the molding cavity and then cured to form a resilient foamed core with an open cell structure. Similar to the first embodiment, water is used as a preferred blowing agent to mitigate adverse environmental impact. The foamed core is firmly bonded to the skin and the rigid insert, especially through the longitudinally running ribs, during the curing process, for example, with adhesive agents.

Although the foam core and the outer skin in the exemplary embodiments are made of polyurethane, it will be appreciated that polyurethane is only an example of an appropriate non-thermoplastic material suitable for making foamed articles, and other non-thermoplastic materials could be used without loss of generality.

1. A molded foam article comprising a foamed core of an expanded non-thermoplastic foam material which is bonded to a skin of un-expanded or minimally expanded non-thermoplastic material, wherein the skin includes wrap-around portions which contains the foamed core, and wherein a first surface portion is intermediate the lateral wrap-around portions which define a lateral extent of the foamed core; and wherein each of the lateral wrap-around portions extends transversely in a continuous and/or jointless manner from the first surface portion.

2. A foam article according to claim 1, wherein the skin is compressively molded of un-expanded or minimally expanded polyurethane, and the foamed core is formed using water as blowing agents.

3. A foam article according to claim 1, wherein the first surface portion is a major surface which is adapted for providing cushioning during normal use.

4. A foam article according to claim 1, wherein the skin forms the exterior or outermost layer of the foam article, and the wrap-around portions are rounded.

5. A foam article according to claim 1, wherein each wrap-around portion receives a lateral extreme of the foamed core and comprises a plurality of concave portions, the concave portions of the wrap-around portions being collectively arranged to turn the lateral ends of the skin towards each other, and each concave portion being jointless or continuous.

6. A foam article according to claim 5, wherein each concave portion comprises two rounded concave bends, the concave bends collectively defining the thickness profile of the foamed core.

7. A foam article according to claim 1, wherein the foamed core and the skin are also bonded to a rigid insert, the rigid insert being on opposite side of the first surface portion.

8. A foam article according to claim 7, wherein the skin and the rigid insert collectively define the volume of the foamed core.

9. A foam article according to claim 7, wherein the rigid insert extends laterally between the wrap-around portions and longitudinally along the length of the article, the skin being bonded to the rigid insert at its free lateral ends and longitudinally.

10. A foam article according to claim 7, wherein the rigid insert comprises longitudinally extending ribs which are embedded into the foamed core.

11. A foam article according to claim 7, wherein the rigid insert is formed of hard plastics or metal such as steel.

12. A foam article according to claim 7, wherein the rigid insert comprises fastening means for anchoring onto furniture.

13. A foam article according to claim 1, wherein the skin layer is formed of polyurethane (PU) or latex.

14. A foam article according to claim 1, wherein the foamed core has an open cell structure.

15. A foam article according to claim 1, wherein the foam core is formed of expanded polyurethane (PU).

16. A foam article according to claim 1, wherein the foam core is formed of a lower density polyurethane and the skin is formed of a higher density polyurethane.

17. A foam article according to claim 1, wherein thickness of the skin layer is less than or equal to 2 mm, and preferably less than or equal to 1.5 mm.

18. A foam article according to claim 1, wherein the article is an arm rest, the first surface portion being adapted for arm resting.

19. A foam article according to claim 1, wherein the article is a cushioning article, such as a cushioning accessory for computer peripherals, the first surface portion being adapted for impact absorption.

20. A foam article according to claim 1, wherein the foam article is a toy, such as a foamed ball or a doll, comprising a child friendly contact surface.

21. A process of forming a foam article by molding on molds which comprises a first upper mold, a first lower mold and a mold core, the first upper mold and the first lower mold collectively defining a molding cavity for receiving the mold core, the mold core being arranged to form a skin with jointless lateral wrap-around portions about its lateral ends upon closure of the first upper mold and the first lower mold and when the molding cavity is filled with a skin forming agent, the process comprising:
delivering a skin forming agent into the molding cavity,
inserting the mold core into the molding cavity, the mold core being arranged to compressively form a skin layer with jointless lateral wrap-around portions about its lateral ends upon closure of the lower and upper molds,
curing the skin forming agent with no or minimal expansion to form a skin layer with jointless lateral wrap-around portions within the cavity formed between the first upper mold, the mold core and the first lower mold,
delivering a foaming agent into the cavity formed with the skin layer, and
curing the foaming agent to form a foamed core.

22. A process according to claim 21, further including attaching a rigid insert onto the foamed core and bonding the rigid insert to the lateral ends of the wrap-around portions of the skin.

23. A process according to claim 21 wherein the lateral ends of the wrap-around portion of the skin are defined by a space between the mold core and the upper and lower molds upon closure of the upper and lower molds.

24. A process according to claim 21, wherein water is used as the blowing agent.

25. A process according to claim 21 wherein the step of delivering a skin forming agent into the molding cavity is performed by open mold pour.

26. A process according to claim 21, wherein the step of delivering a foaming agent into the cavity formed with the skin layer and the step of curing the foaming agent to form a foamed core occur in molds other that the mold for curing the skin forming agent.
